(19) United States
(12) Patent Application Publication
(10) Pub. No.: US 2009/0097001 A1
(43) Pub. Date: Apr. 16, 2009

(54) Non-Telecentric Lithography Apparatus and Method of Manufacturing Integrated Circuits

(75) Inventors: Sven Trogisch, Dresden (DE); Joerg Tschischgale, Dresden (DE); Markus Bender, Dresden (DE)

Correspondence Address: EDELL, SHAPIRO & FINNAN, LLC, 1901 RESEARCH BLVD., SUITE 400, ROCKVILLE, MD, 20850, US

(73) Assignee: QIMONDA AG, Munich (DE)

(21) Appl. No.: 11/872,266

(22) Filed: Oct. 15, 2007

(51) Int. Cl. G03B 27/68; G03B 27/42

(52) U.S. Cl. 355/52; 355/53

(57) ABSTRACT

A lithography apparatus includes a condenser system and a projection system. The condenser system is configured to irradiate a mask with non-telecentric incident radiation. The projection system is configured to collect and focus a radiation diffracted at an absorber pattern on the mask to a sample. The projection system is further configured to compensate, in the diffracted radiation, a phase and/or intensity variation resulting from the diffraction of the non-telecentric incident radiation, wherein the diffraction results from an absorber pattern provided on the mask.

### BACKGROUND

Extreme ultraviolet lithography (EUV) uses reflective photomasks with an oblique illumination angle, resulting in imaging characteristics that differ from those of conventional optical lithography. For example, the topography of an absorber pattern on top of a reflective mask may cause shadow effects for absorber lines that run perpendicular to the plane of incidence resulting in structure displacement and alterations of lateral dimensions of the imaged structures. Optical proximity correction techniques may be implemented to adapt the absorber structures on the mask to compensate shadow effects to a certain degree. Shadow effects may also occur with conventional, transmissive optical lithography.

Further, during manufacturing of an integrated circuit, a plurality of exposure processes are necessary, wherein patterns resulting from different exposure processes must be adjusted to each other. The patterns to be imaged are provided such that they show a tolerance against a maximum admissible misalignment of the lithographic exposures. The greater the inherent imaging aberrations, for example, resulting from non-telecentric illumination, are, the greater this tolerance must be on costs of substrate space and yield.

Therefore a need exists for a lithography apparatus and a method of manufacturing integrated circuits which may reduce the required overlay tolerances.

### SUMMARY

Described herein is a lithography apparatus that comprises a condenser system and a projection system. The condenser system is configured to irradiate a mask with non-telecentric incident radiation. The projection system is configured to collect and focus a radiation diffracted at an absorber pattern on the mask to a sample. The projection system is further configured to compensate, in the diffracted radiation, a phase and/or intensity variation resulting from the diffraction of the non-telecentric incident radiation, wherein the diffraction results from an absorber pattern provided on the mask.

The above and still further features and advantages of the present invention will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

Features and advantages of exemplary embodiments of the apparatus and method will be apparent from the following description of the drawings. The drawings are not to scale. Emphasis is placed upon illustrating the principles.

FIG. 1A is a schematic perspective illustration of a non-telecentric illumination of a mask.

FIG. 1B is a schematic plan view of a section of the mask of FIG. 1A comprising absorber lines perpendicular to a main plane of incidence.

FIG. 1C is a schematic cross-sectional view of the section of the mask of FIG. 1B.

FIG. 1D is a schematic plan view of a section of the mask of FIG. 1A comprising absorber lines running parallel to a main plane of incidence.

FIG. 1E is a schematic cross-sectional view of the section of the mask of FIG. 1D.

FIG. 1F is a diagram illustrating the effect of non-telecentric illumination of the mask of FIG. 1A.

FIG. 2 is a schematic illustration of a non-telecentric illumination of a reflective mask.

FIG. 3A is a schematic illustration of a projection system for telecentric illumination.

FIG. 3B is a schematic illustration of a conventional projection system for non-telecentric illumination.

FIG. 3C is a schematic illustration of a projection system of a lithography apparatus for non-telecentric illumination according to an exemplary embodiment using phase compensation.

FIG. 3D is a schematic illustration of a projection system of a lithography apparatus for non-telecentric illumination according to a further embodiment using intensity compensation.

FIG. 4 is a schematic illustration of a lithography apparatus for non-telecentric illumination according to another embodiment.

FIGS. 5A-5E are schematic plan and cross-sectional views of compensation elements for a lithography apparatus for non-telecentric illumination according to further embodiments.

FIG. 6 is a schematic illustration of another compensation element mounted on a EUV pellicle according to another embodiment.

FIG. 7 is a flow chart of a method of manufacturing integrated circuits according to a further embodiment.

### DETAILED DESCRIPTION

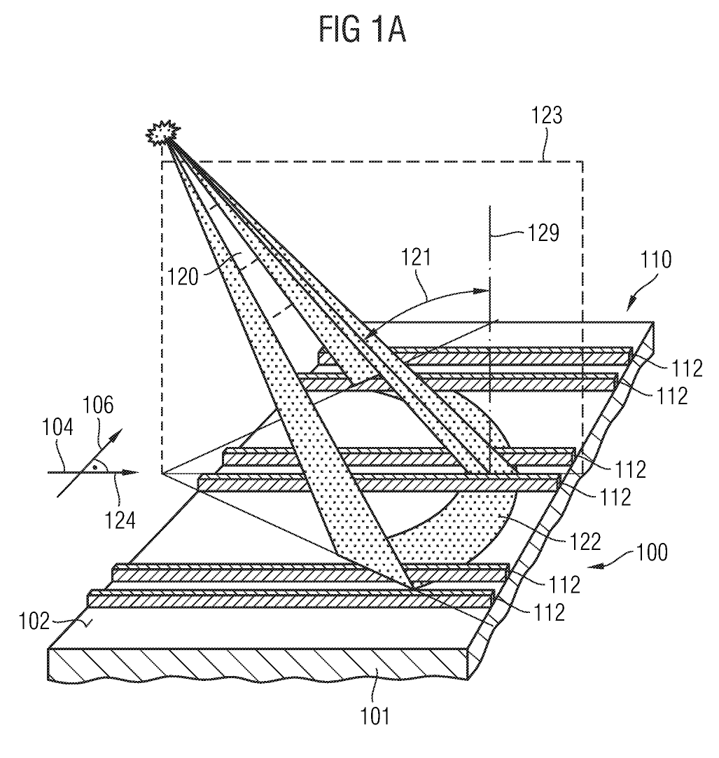

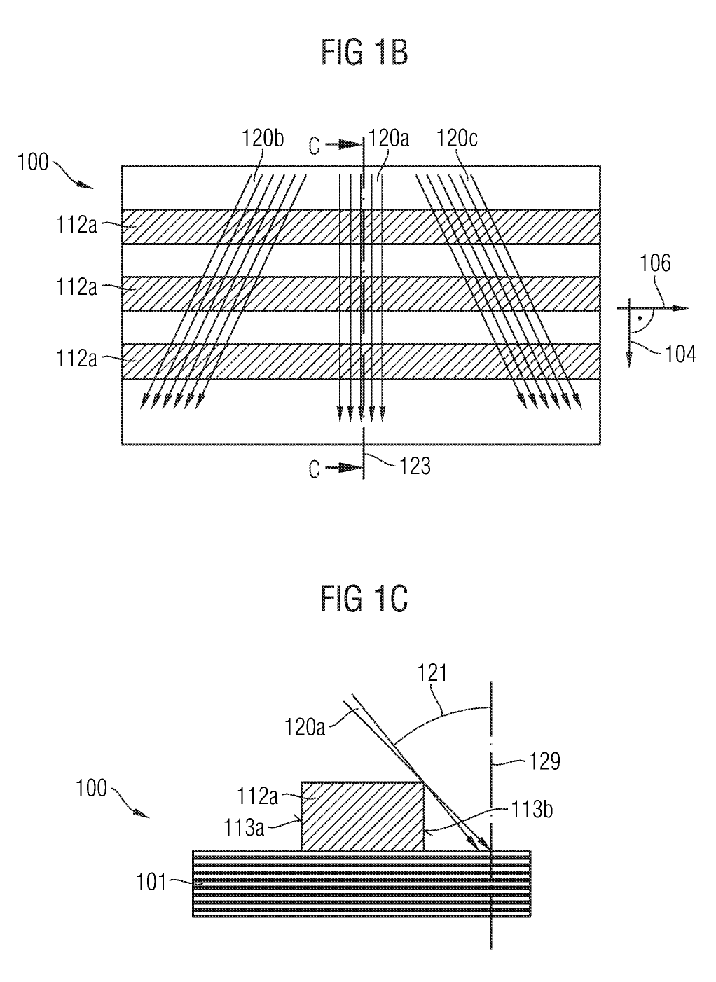

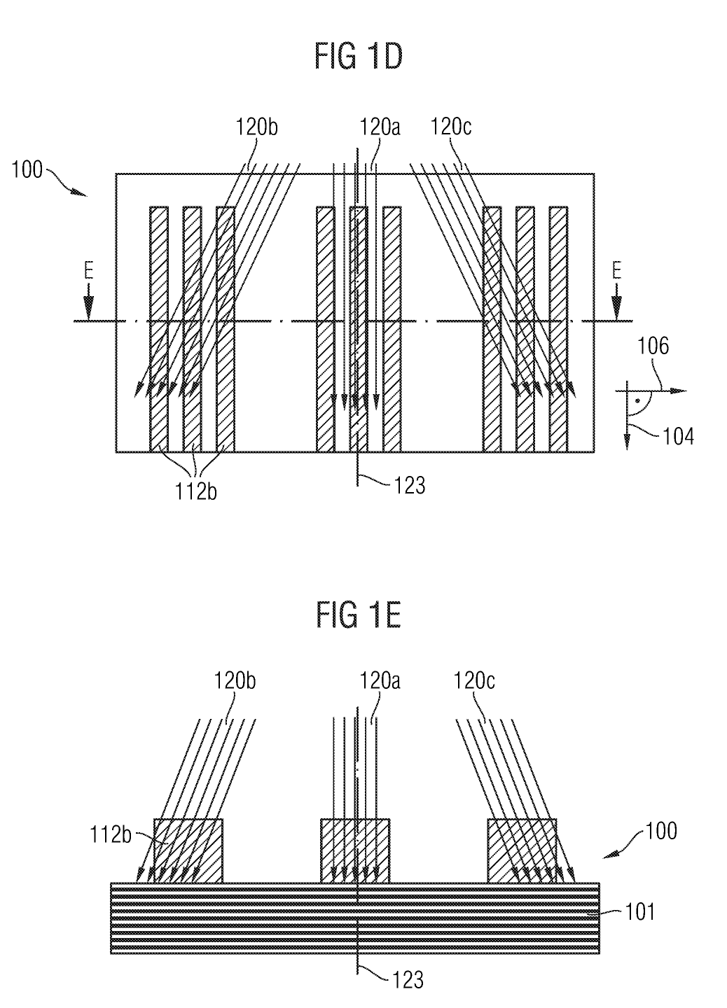

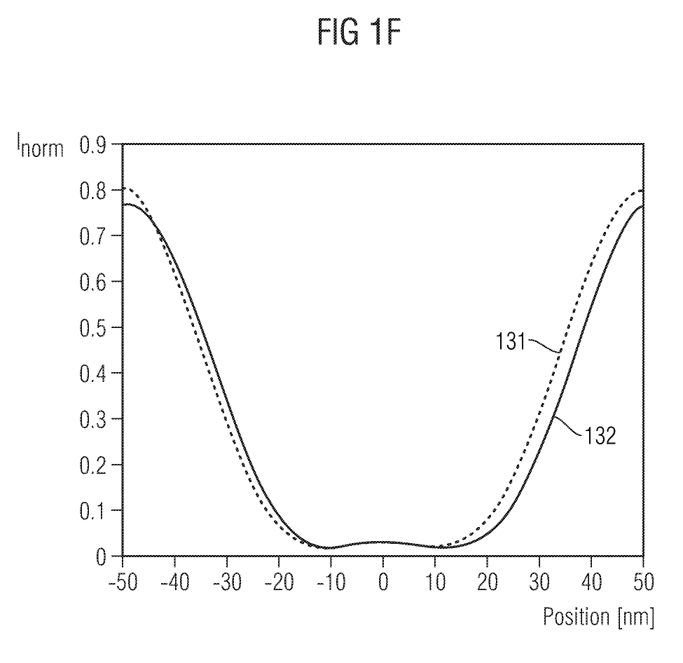

FIGS. 1A to 1E refer to a simplified illustration of an incident illumination beam 120 irradiating a mask or reticle 100 for illustrating effects of non-telecentric illumination.

The mask 100 illustrated in FIG. 1A comprises an absorber pattern 110 arranged on a non-absorbing surface 102 of a substrate 101. The absorber pattern 110 comprises absorber structures 112 which may be oval, elliptic or circular dots or dots of, for example, rectangular shape with or without rounded corners. The absorber structures 112 may also be lines which may comprise straight sections extending along a first axis 104 or a second axis 106 which is perpendicular to the first axis 104. The absorber structures 112 may also comprise slanted sections running oblique to the first and second axes 104, 106. At an illumination wavelength of, for example 13.5 nm, 193 nm, 198 nm, 248 nm, 257 nm or any other wavelength used for mask illumination, the absorber pattern 110 has an absorbance that is significantly greater than that of the non-absorbing surface 102 at the same wavelength.

The substrate 101 is either transparent or to a high degree reflective at the illumination wavelength. An illumination beam 120 irradiates the mask 100 with a radiation at the illumination wavelength. The radiation from, for example an EUV source, is collected and shaped to the illumination beam 120, which illuminates an image field that may be, by way of example, a narrow arc or an annular segment (ring field) 122. The width of the image field is selected sufficiently narrow to achieve sufficient contrast on one hand and sufficiently wide to get enough radiation for exposing, by way of example, a resist on a target substrate, into which the absorber pattern 110 is imaged and transferred. The width may be in the range of up to several millimeters. The length of the image field may be selected, for example, such that it extends over at least the minimum dimension (length or width) of a pattern region of the mask 100, such that the pattern may be screened or scanned in one contiguous scan. A typical width or length of the mask 100 is in the range of 80 to 150 mm. The mean radius of the ring field is limited by technical restrictions of the condenser optics of the lithography apparatus. Within this restriction the mean radius is selected as large as possible. The illumination beam 120 may be symmetric with respect to a main plane of incidence 123 which is orthogonal to the non-absorbing surface 102 and which extends along, for example, the first axis 104. The illumination is non-telecentric, meaning that, in the main plane of incidence 123, the illumination beam 120 has a mean incident angle 121 which is not equal zero with respect to the normal 129 but is about four to ten degrees, for example six to nine degrees. By way of example, the illumination beam 120 may scan the mask 100 parallel to the first axis 104, for example along a first direction 124, which faces away from the incident illumination beam 120 on the first axis 104.

The mask 100 may be mounted on a mask stage that moves the mask 100 during an illumination period, for example reverse to the first direction 124, such that a scan direction, along which the illumination beam 120 scans the mask 100, corresponds to the first direction 124.

According to an embodiment, the illumination beam 120 is EUV radiation of a wavelength of 13.5 nanometer. The absorber structures 112 may be tantalum nitride based and the substrate 101 may include a multi-layer reflector comprising, for example, 20 to 60 molybdenum and silicon layers in alternating order. In accordance to further embodiments, the mask 100 may further comprise a capping layer, for example a ruthenium layer, arranged on top of the multi-layer reflector.

According to another embodiment, the illumination radiation 120 is a DUV (deep ultraviolet) radiation (e.g., 193 nanometer wavelength), the absorber structures 112 are, for example, chromium structures, and the substrate 101 may be a doped silicon oxide (e.g., a titanium doped silicon dioxide).

FIG. 1B is a schematic plan view of a section of the mask 100 comprising line-shaped absorber structures 112a running perpendicular to the first axis 104, wherein a first portion 120a of the illumination beam impinges in the main plane of incidence 123 and the rest, for example, of the portions 120b, 120c are tilted to the main plane of incidence.

As illustrated in FIG. 1C, which is a cross-sectional view of the section of the mask 100 illustrated in FIG. 1B, the absorber structures 112a running perpendicular to the first axis 104 shadow the incident illumination radiation at their trailing sidewalls 113b, which face away from the incident illumination beam 120. In addition, in case of a reflective substrate 101, the absorber structures 112a shadow a portion of a reflected illumination radiation on their leading sidewalls 113a which face the incident radiation 120a. Further, the effective angle of incidence varies over the image field, wherein the variation is symmetric to the main plane of incidence 123. As a result, in the reflected or transmitted radiation, a feature on the mask appears wider than it actually is and the feature appears to be shifted in a direction determined by the incident angle, the height of the absorber pattern and the distance of the respective object point to the main plane of incidence 123.

FIG. 1D is another schematic plan view of another section of the mask 100 comprising line-shaped absorber structures 112b running parallel to the first axis 104, wherein a first portion 120a of the illumination beam incidents in the main plane of incidence 123 and further portions 120b, 120c tilted to the main plane of incidence.

As illustrated in FIG. 1E, which is a cross-sectional view of the section of the mask 100 as illustrated in FIG. 1D, with the absorber structures 112b running parallel to the first axis 104 a shadowing effect as discussed above occurs tilted to the main plane of incidence 120, 120a, wherein the effect is symmetric with respect to the main plane of incidence 123. The same considerations as presented in the following with respect to the shadowing effect illustrated in FIG. 1C may therefore apply likewise to the shadowing effect as illustrated in FIG. 1E.

The diagram of FIG. 1F shows the effect of the non-telecentric illumination of absorber lines 112a, 112b as depicted in FIGS. 1B and 1D on corresponding target lines printed on a target substrate. The dotted curve 131 plots the normalized illumination intensity assigned to one focus plane as a function of a distance to a center of the target line, corresponding to an absorber line 112b running parallel to the main plane of incidence, while the continuous curve 132 refers to an absorber line 112a running perpendicular to the main plane of incidence. A printed line resulting from the “perpendicular” absorber line 112a is wider and is shifted in a direction determined by the orientation of the mean incident angle 121.

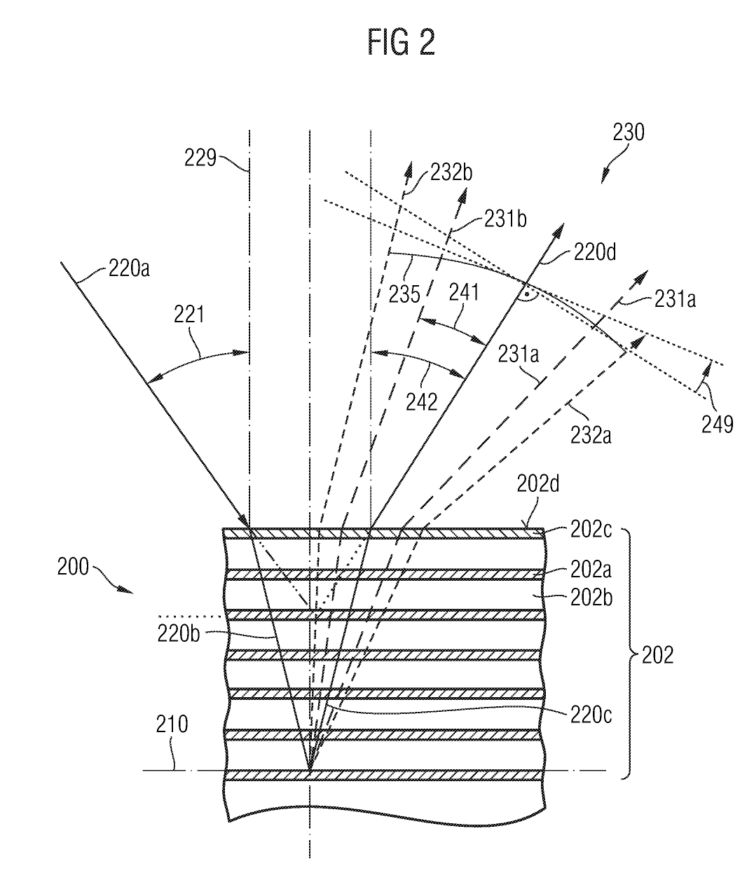

FIG. 2 refers to a further aspect of non-telecentric illumination. Though explained in detail with respect to a reflective mask in the following, essentially the same considerations apply to transparent masks as well. The reflective mask 200 may comprise a multilayer reflector 202 which includes layers of different indices of refraction and/or different coefficients of absorption, for example, first layers 202a having a first index of refraction and second layers 202b having a second index of refraction, in alternating order. In accordance to further embodiments, a capping layer 202c (e.g., a ruthenium layer) may be disposed on top of the multi-layer reflector 202. Radiation entering the multilayer reflector 202 is partly reflected at each interface between a first layer 202a and a second layer 202b. The distance between the interfaces may be such that radiation reflected at the interfaces superposes in-phase. Due to this superposition, the plurality of reflections may be assumed as one reflection occurring on a virtual reflection plane 210.

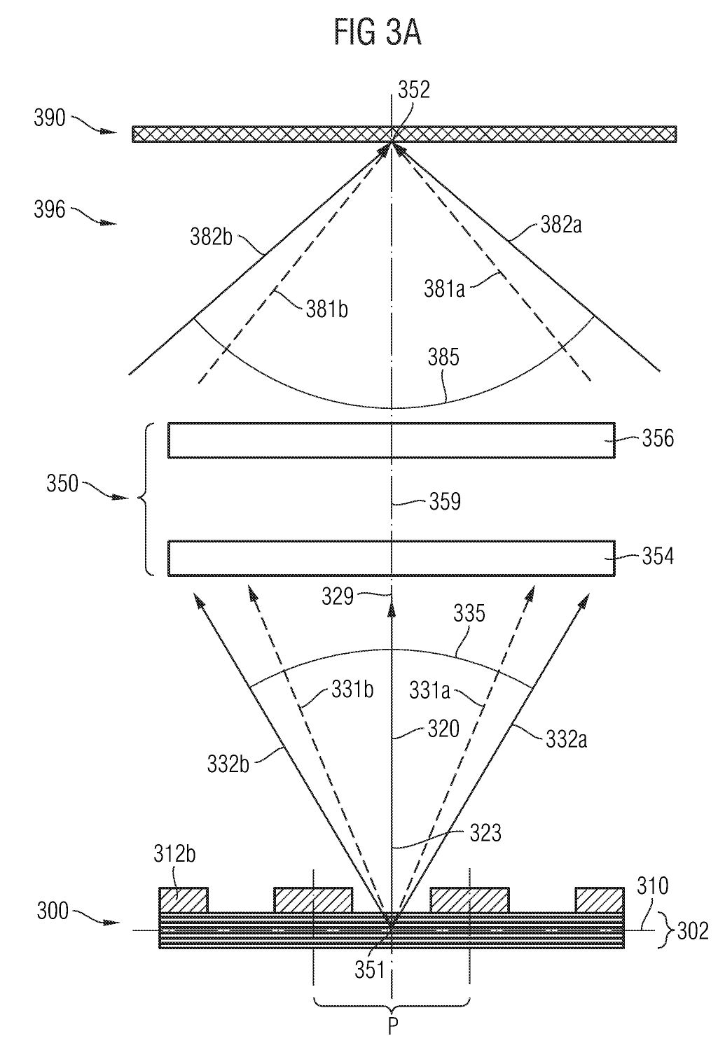

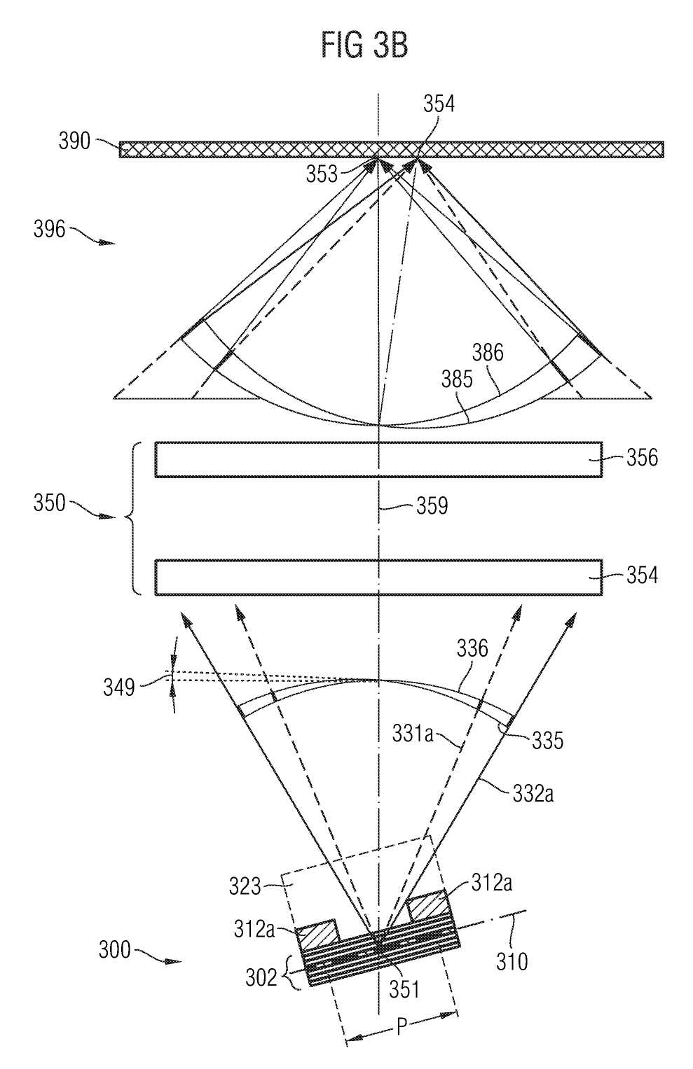

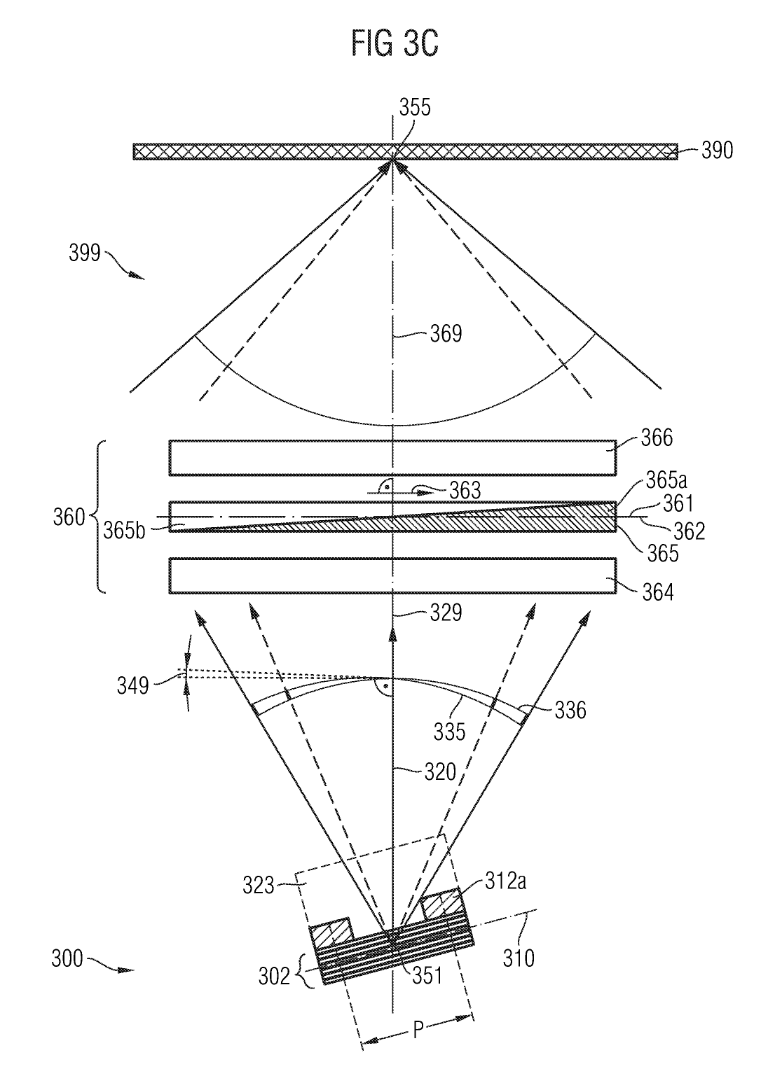

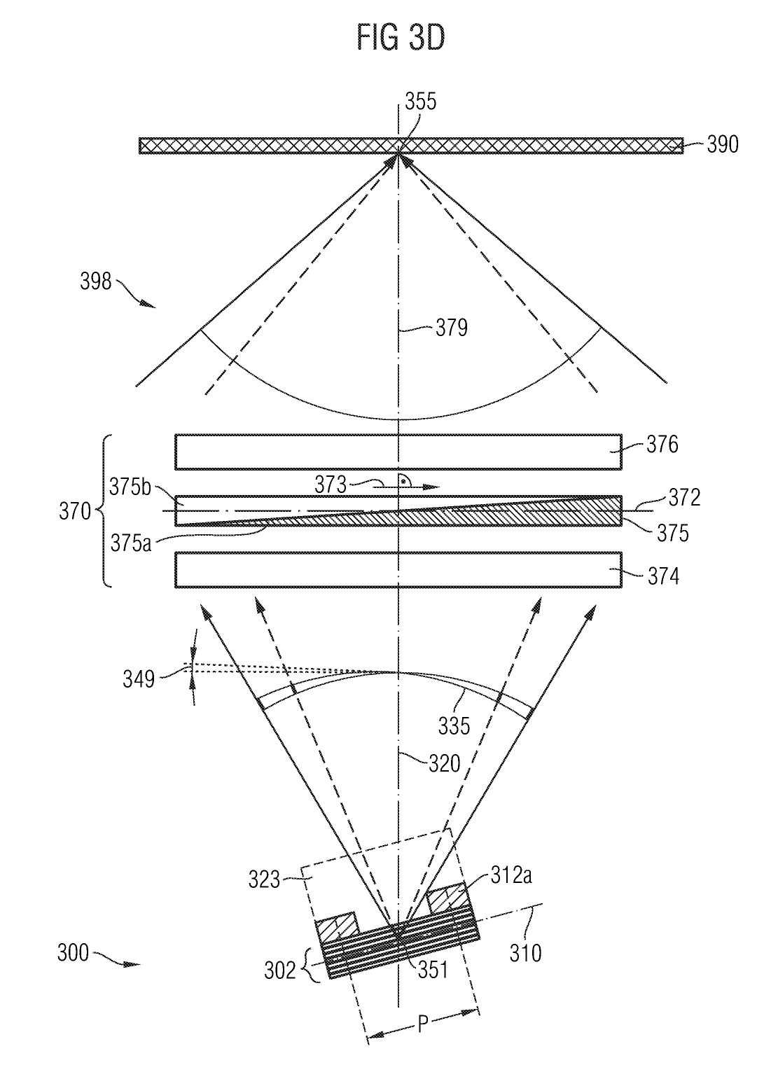

Further, diffraction occurs due to an absorber pattern disposed above the multi-layer reflector 202, wherein, for example, a regular line pattern may be effective as a reflective grating as will be explained in detail with regard to FIG. 3B. Further by approximation, the points of diffraction may be assumed in the virtual reflection plane 210.

An incident illumination beam 220a impinges on the multi-layer reflector 202 at an incident angle 221 off normal 229. As the refractive index of the multi-layer reflector differs from that of air or vacuum, the incident illumination beam 220a is refracted on the surface 202d of the multi-layer reflector 202. The illumination beam 220a may be refracted towards the normal 229 as illustrated. In case of EUV illumination at a wavelength of 13.5 nm, for example, the refractive index of the multi-layer reflector 202 may be less than 1 and the incident illumination beam 220a is refracted away from the normal 229. The refracted incident illumination beam 220b appears to be reflected at the virtual reflection plane 210 and the reflected refracted illumination beam 220c is refracted towards or away from the normal 229 at the surface 202d and spreads from the mask 200 as reflected illumination beam 220d.

If diffraction occurs, the reflected illumination beam 220d spreads out in the respective plane of incidence. By way of example, in the case of a regular line or dot pattern, for example, parallel absorber lines arranged at a predefined pitch, a regular diffraction pattern with first 231a, 231b, 232a, 232b and higher diffraction orders occurs in the reflected radiation 230. The respective angle of diffraction 241, 242 of equivalent orders of diffraction depends on the pitch of the absorber lines. A wide angle of diffraction 242 of the first diffraction orders 232a, 232b corresponds to a narrow pitch and a narrow angle of diffraction 241 of the first diffraction order 231a, 231b corresponds to a wide pitch. In the case of absorber lines extending parallel to the main plane of incidence 123, the diffraction orders spread exclusively in a plane perpendicular to the main plane of incidence 123 and symmetrically thereto.

Due to the non-telecentric illumination and to the effective refractive index of the multi-layer reflector, which is different from that of air or vacuum, a phase shift and an intensity gradient occurs in the wavefront 235 spreading from the surface 202d of the multi-layer reflector 202. If the effective index of refraction of the multi-layer reflector 202 is greater than that of air/vacuum, trailing diffracted portions facing away from the incident illumination beam 220a are delayed and reduced with respect to leading diffracted portions facing the incident illumination beam 220a in the respective plane of incidence. If the effective index of refraction of the multi-layer mirror 202 is less than that of air/vacuum, the leading diffracted portions are delayed and reduced with respect to the trailing diffracted portions. The following description refers to an effective index of refraction of greater than 1. Equivalent combinations apply to an EUV mask, the multi-layer reflector of which has typically an index of refraction less than 1 at an illumination wavelength of, for example, 13.5 nm. A wavefront 235 characterizing radiation of the same phase in the reflected radiation 230 is tilted at a pitch-dependent delay angle 249 with respect to a wavefront which spreads out perpendicular to the reflected illumination beam 220d in the case of diffraction occurring in a diffraction plane perpendicular to the main plane of incidence, for example, an absorber pattern being effective as reflective grid and including absorber lines parallel to the main plane of incidence.

Further, due to the difference in path length through the multi-layer reflector 202 and its not negligible absorbance at the illumination wavelength, the intensity of the diffracted radiation depends on the respective effective angle of diffraction. Inter alia, the intensity of the plus and minus diffraction orders may differ from each other, wherein the difference depends on the feature pitch of the absorber lines.

FIGS. 3A to 3D relate the effect as described with regard to FIG. 2 to exemplary embodiments. FIG. 3A illustrates the propagation of radiation between a mask 300 and a sample 390 through a projection system 350 of a lithography apparatus 396 in case of telecentric illumination of a regular absorber pattern being effective as reflective grid and comprising parallel absorber lines 312b at a feature pitch p and running parallel to the main plane of incidence 323. The incident illumination beam appears to be reflected in an object point 351 in a virtual reflection plane 310 within a multi-layer reflector 302 of a reflective mask 300. The reflected radiation 320 propagates along the normal 329 and symmetric thereto. Spreading of the diffracted radiation is visualized by a wavefront 335 indicating diffracted radiation of the same phase and by first order diffractions 331a, 331b, referring to a wide feature pitch p and by further first order diffractions 332a, 332b referring to a narrow feature pitch p.

A projection system 350 with an optical axis 359 parallel to the main plane of incidence 323 focuses the diffracted radiation on an image point 352 on the sample 390, which may be, for example, on or in a resist layer of a semiconductor wafer for manufacturing integrated circuits. The projection system 350 may have elements 354, 356 that are reflective or transparent at the illumination wavelength. The exit wavefront 385 on the image side of the projection system 350 is in phase and symmetric to the optical axis 359 such that, in case of the regular absorber pattern as described above, all diffraction orders may impinge on the sample 390 in the same image point 352 at the same time and independently of the feature pitch p.

FIG. 3B refers to non-telecentric illumination of an absorber pattern being effective as reflective grid and comprising parallel absorber lines 312a at a feature pitch p and running perpendicular to the main plane of incidence 323. The mask 300 is tilted at the angle of incidence to the optical axis 359 of the projection system 350 of the lithography apparatus 396 such that the reflected radiation 320 is parallel to the optical axis 359. For the reasons discussed with regard to FIG. 2, the entrance wavefront 335 remains tilted at an delay angle 349 to a virtual wavefront 336 spreading along the normal 329. The projection system 350 focuses the tilted entrance wavefront in a tilted exit wavefront 385. The projection system 350, which would image a non-tilted wavefront 336 into a corresponding non-tilted wavefront 386 and into a virtual image point 353, images the same object point into an actual image point 354, which is displaced from the virtual image point 353 by a distance which depends on the delay angle 349. The delay angle 349 in turn is a function of the properties of the multi-layer reflector 302 and the angle of incidence.

FIG. 3C refers to a projection system 360 of a lithography apparatus 399 according to an exemplary embodiment. A non-telecentric illumination beam appears to be reflected in an object point 351 in a virtual reflection plane 310 within a multi-layer reflector 302 of a reflective or transparent mask 350 comprising, for example, a regular absorber pattern with parallel absorber lines 312a at a feature pitch p and running perpendicular to the main plane of incidence 323. The reflected radiation 320 propagates along the normal 329, wherein an entrance wavefront 335 is tilted at a delay angle 349 to an entrance plane of the projection system 360. The projection system 360 focuses the reflected and diffracted radiation at an image plane on or in a target sample 390 and images the object point 351 into the image point 355.

The projection system 360 may comprise a phase compensation element 365 that is placed in the optical path of the projection system 360. The phase compensation element 365 is configured to compensate the effect of the tilted wavefront 335, in other words, of the delay angle 349, such that a pattern shift in the image plane which would result from the delay angle 349, is at least reduced.

The phase compensation element 365 may be arranged in or next to a pupil plane 362 of the projection system 360. The pupil plane 362 may be located between two reflective or transmissive optical elements 364, 366 of the projection system 360. In the pupil plane 362, the distance to the optical axis 369 of the projection system 360 corresponds to an angle in the reflected radiation. Such an arrangement of a phase compensation element 365 facilitates a mapping of locations on the phase compensation element 365 to an angle under which an object point emits or reflects radiation. As discussed above, the tilted wavefront 335 indicates that the phase deviation depends on the diffraction angle, wherein the phase deviation increases with increasing angle of diffraction. With regard to patterns with parallel absorber lines 312a and using, for example, first diffraction orders for imaging purposes, the phase deviation of the first diffraction orders is pitch dependent. A slight displacement of the phase compensation element 365 from the pupil plane 362 may be admissible as long as the effect of displacement does not outweigh an improvement resulting from the insertion of the phase compensation element 365.

The phase compensation element 365 in or next to the pupil plane 362 may extend over the entire aperture of the projection system 360 in the pupil plane 362, and is essentially transparent at the illumination wavelength. In this context, a phase compensation element 365 may be considered as being transparent, if its transparency at the illumination wavelength is at least 10%. The phase compensation element 365 may have a phase shift gradient, for example, an increasing path length for the illumination wavelength along an element axis 361, which is perpendicular to the optical axis 369 and parallel to a projection plane of the main plane of incidence 323 in the pupil plane 362.

Referring to a multi-layer mirror 302 having an effective index of refraction at the illumination wavelength that is greater than 1, the phase compensation element 365 may be provided with linearly decreasing path length for the illumination wavelength along a first direction 363, along which portions of the wavefront impinge in the pupil plane with increasing delay along the element axis. The first direction 363 is predetermined in the projection system 360 by the orientation of the angle of incidence. Referring to a multi-layer mirror 302 having an effective index of refraction at the illumination wavelength that is less than 1, the phase compensation element 365 may be provided with linearly increasing path length for the illumination wavelength along the first direction 363.

According to an embodiment, the phase compensation element 365 comprises a phase shift layer 365a of a first material, wherein the thickness of the phase shift layer increases along the first direction 363. According to a further embodiment, the phase compensation element 365 comprises further a matching layer 365b configured to compensate a varying transparency of the phase shift layer 365a along the first direction 363. The matching layer 365b may be of a second material, the transparency of which at the illumination wavelength is substantially the same as that of the first material, wherein the second material does not substantially influence the phase of the radiation. According to another embodiment, the thickness of the phase shift layer is constant and the effective refractive index is locally altered, for example, by a dopant, wherein the dopant concentration increases or decreases along the element axis 361. In accordance with further embodiments, the profile of the phase shift layer 365a may have steps or may be staggered or curved.

As shown in FIG. 3D, alternatively or in addition, a projection system 370 of a lithography apparatus 398 according to a further embodiment may comprise an intensity compensation element 375 that is placed in the optical path of the projection system 370. The intensity compensation element 375 is configured to compensate the effect of intensity deviation along the tilted wavefront 335, in other words, of the different path length of portions in the diffracted radiation in the mask 300, such that a pattern aberration in the image plane, which would result from the intensity aberration, is at least significantly reduced, for example, by 50 percent.

The intensity compensation element 375 may be arranged in or next to a pupil plane 372 of the projection system 370 of a lithography apparatus 398. The pupil plane 372 may be located between two reflective or transmissive optical elements 374, 376 of the projection system 370 or on a reflective element or in a transmissive element. In the pupil plane 372, the distance to the optical axis 379 of the projection system 370 corresponds to an angle in the diffracted radiation. Such an arrangement of an intensity compensation element 375 facilitates a mapping of locations on the intensity compensation element 375 to an angle under which an object point appears. As discussed above, the intensity may increase along the tilted wavefront 335 with increasing angle to the incident illumination beam. With regard to regular absorber line patterns using first diffraction orders for imaging purposes, the intensity deviation between the plus first and minus diffraction orders is pitch dependent. A slight displacement of the intensity compensation element 375 from the pupil plane 372 may be admissible as long as the effect of displacement does not outweigh an improvement resulting from the insertion of the intensity compensation element 375.

The intensity compensation element 375 in or next to the pupil plane 372 may extend over the entire aperture of the projection system 370 in the pupil plane 372 and may be essentially transparent at the illumination wavelength. In this context, an intensity compensation element 375 may be considered as being transparent, if its transparency at the illumination wavelength is at least 10%. The intensity compensation element 375 may have a transparency gradient, for example a decreasing transparency for the illumination wavelength along an element axis, which is perpendicular to the optical axis 379 and parallel to a projection plane of the main plane of incidence 323 in the pupil plane 372.

The intensity compensation element 375 may be provided with linearly increasing transparency for the illumination wavelength along a first direction 373, along which portions of the wavefront may impinge in the pupil plane 372 with decreasing intensity. The first direction 373 is given in the projection system 370 by the orientation of the angle of incidence.

According to an embodiment, the intensity compensation element 375 comprises an intensity matching layer 375a of a third material, wherein the thickness of the intensity matching layer 375a decreases along the first direction 373. According to a further embodiment, the intensity compensation element 375 comprises further a retention matching layer 375b configured to compensate a varying retention of the intensity matching layer 375a along the first direction. The retention matching layer 375b may be of a forth material, the retention properties of which at the illumination wavelength are substantially the same as that of the third material, wherein the forth material does not influence the intensity of the radiation.

According to another embodiment, the projection system comprises both a phase compensation element and an intensity compensation element. Another projection system comprises a combined compensation element which acts as both a phase compensation element and an intensity compensation element.

According to another embodiment, the members of the projection system 360 are designed to compensate the phase shift and/or the intensity aberration in the radiation diffracted by the pattern on the mask 300. The projection systems 360, 370 may be pure reflective ones with mirrors, pure transparent ones with lenses or combined ones with mirrors and lenses.

According to a further embodiment, at least one of the optical elements of the projection systems 360, 370 may be configured to compensate the phase shift and/or the intensity variation in the radiation diffracted by the pattern on the mask 300. If the respective optical element is arranged in or next to a pupil plane 362, a phase shift and/or intensity matching layer may be provided on that surface of one of the respective optical elements which in the optical path. According to another embodiment, one or more of the optical elements may be designed to compensate the phase shift and/or the intensity variations in a manner such that the compensation is effective for all pitches on the mask to essentially the same degree.

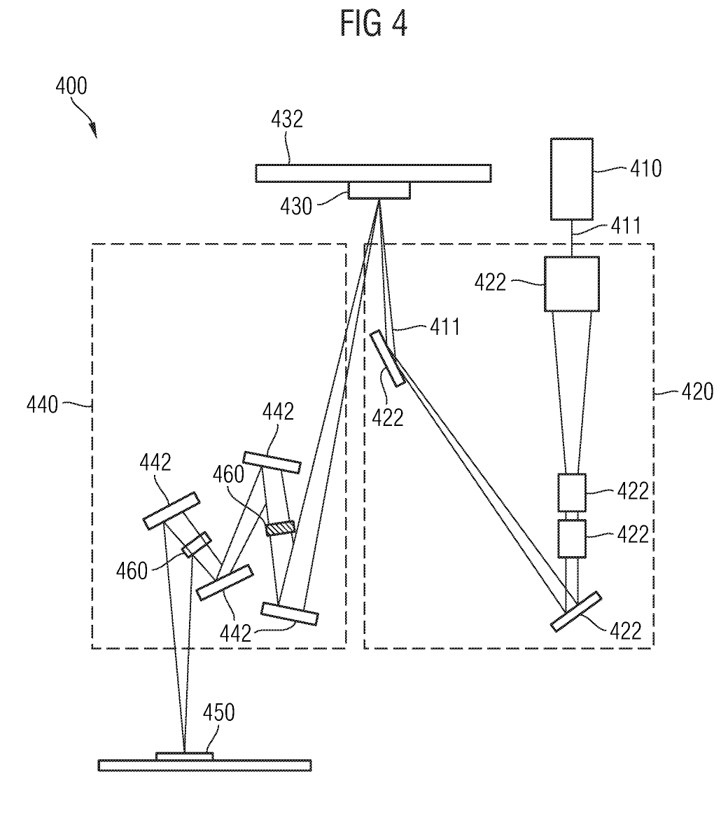

FIG. 4 is a schematic illustration of a lithography apparatus 400 with reflective elements according to an embodiment. The lithography apparatus 400 comprises a radiation source 410 which may be any source capable of producing radiation used for reflection lithography (e.g., an EUV source).

A condenser system 420 guides radiation 411 emitted from the radiation source 410 to a mask 430 which may be mounted on a mask stage 432. The condenser system 420 includes condenser optics 422 (e.g., mirrors) which are reflective at the radiation wavelength and which collect and focus the radiation 411 onto the mask 430. The condenser system 420 may include a plurality of condenser optics 422, for example, five as shown in FIG. 4. The radiation 411 impinges on the mask 430 as illumination beam, a typical shape of which is illustrated in FIG. 1A. The mask stage 432 moves the mask 430 during an illumination period along a scan direction. The illumination beam may scan the mask 430 or at least a pattern region of the mask 430 with one continuous unidirectional scan.

The projection system 440 images the pattern on the mask 430 onto a sample 450, which may be, for example, a semiconductor wafer in course of manufacturing integrated circuits and which is coated with a resist layer which is sensitive to radiation at the illumination wavelength. The projection system 440 includes reflective projection optics 442 (e.g., mirrors) that project radiation reflected from the mask 430 onto the sample 450 true to scale or scaled down. In general, focusing projection systems 440 have at least one pupil plane.

According to an embodiment, a phase compensation element 460 is arranged in one of the pupil planes of the projection system 440. According to another embodiment two or more phase compensation elements 460 are arranged in pupil planes of the projection system 440. According to another embodiment, an intensity compensation element 460 is arranged in one of the pupil planes of the projection system 440. According to another embodiment two or more intensity compensation elements 460 are arranged in pupil planes of the projection system 440.

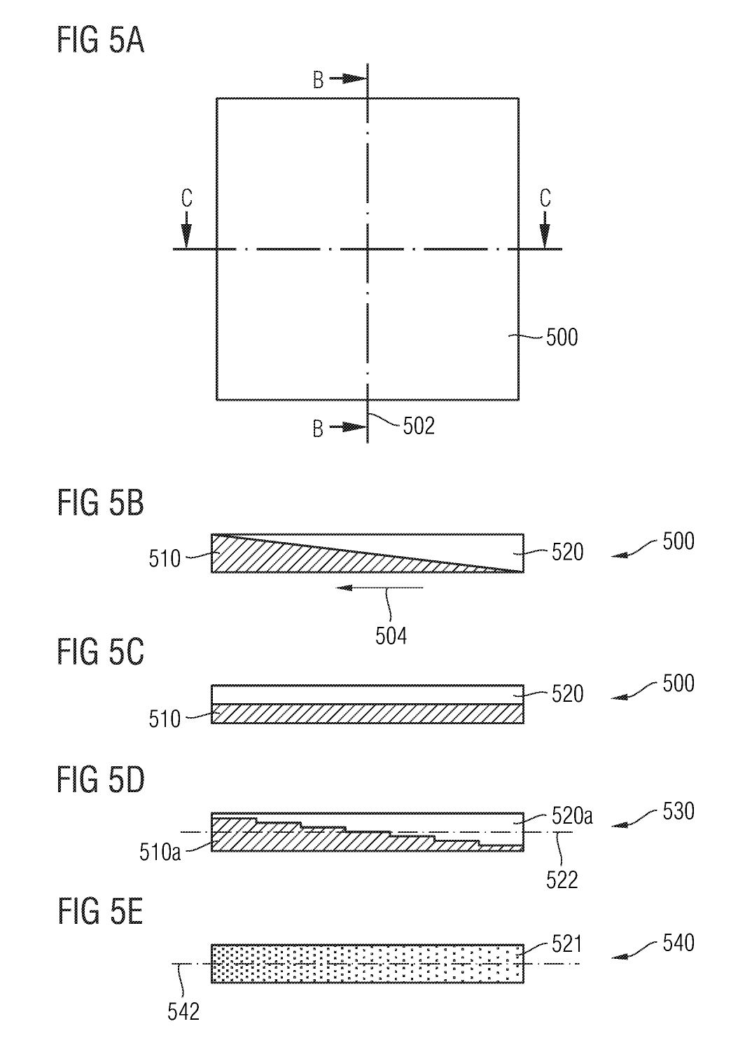

FIGS. 5A to 5C refers to various compensations elements for use in a lithography apparatus as described above. FIG. 5A shows a plan view of a compensation element 500. The compensation element 500 may be round or rectangular as illustrated in FIG. 5A or may have any other shape to cover essentially completely the aperture of the projection system in that pupil plane, in which the compensation element 500 is arranged.

According to FIG. 5B, the compensation element may comprise a compensation layer 510. By way of example, the compensation layer 510 may be configured as phase compensation layer having an effective refractive index which is unequal to that of the ambient. By way of example, the material of the compensation layer may have a refractive index that differs at least by 0.1% from that of air, wherein the maximum thickness variation of the phase compensation layer may be about 50 to about 150 nm over the pupil plane. According to another embodiment, the difference is about 1% and the maximum thickness variation may be about 5 to 10 nm. According to another example, the compensation layer 510 may be configured as intensity compensation layer. In both cases, the thickness of the compensation layer 510 may vary along an element axis 502 which runs parallel to the cross-section B-B. The thickness of the compensation layer 510 may decrease along the element axis 502 along a first direction 504, wherein, when placed in the optical path of a lithography apparatus, the first direction 504 corresponds to that direction along which the incident wavefront impinges with increasing delay or decreasing intensity. The thickness variation is determined such that either a phase shift or an intensity variation in the entrance wavefront, which in each case results from diffraction in the mask, is essentially compensated. According to an embodiment, the thickness may decrease linearly as depicted in FIG. 5B. According to other embodiments, the effective refractive index of the first layer 510 may vary to compensate the phase shift, or a combination of varying thickness and varying effective refractive index may be implemented. In accordance with further embodiments, the profile of the respective compensation layer 365a may have steps or may be staggered or curved.

According to an embodiment, the compensation element 510 comprises exclusively the respective (phase or intensity) compensation layer 510. According to another embodiment shown in FIG. 5B, the compensation element 500 may comprise in addition a matching layer 520. In case of a phase compensation layer 510 the matching layer 520 may be configured to compensate an intensity aberration which results from differing absorbance at different positions of the compensation layer 510. In case of an intensity compensation layer 510, the matching layer 520 may be configured to compensate a locally varying phase shift which results from differing delays at different positions of the compensation layer 510.

As shown in FIG. 5C, the thickness of the compensation layer 510 and the matching layer 520 may be constant along a cross axis perpendicular to the element axis 502. Materials for the various compensation and matching layers are, by way of example, Ruthenium, doped silicone oxides and Molybdenum.

FIG. 5D refers to a compensation element 530, which is shown in a cross-section along the element axis 522 and which shows a staggered profile of the compensation layer 510a and a suitable matching layer 520a.

FIG. 5E shows a cross-section of a compensation element 540 comprising one compensation layer 521, wherein the compensation layer 521 is doped with impurities influencing, for example, the effective index of refraction, wherein the impurity concentration shows a gradient along the element axis 542.

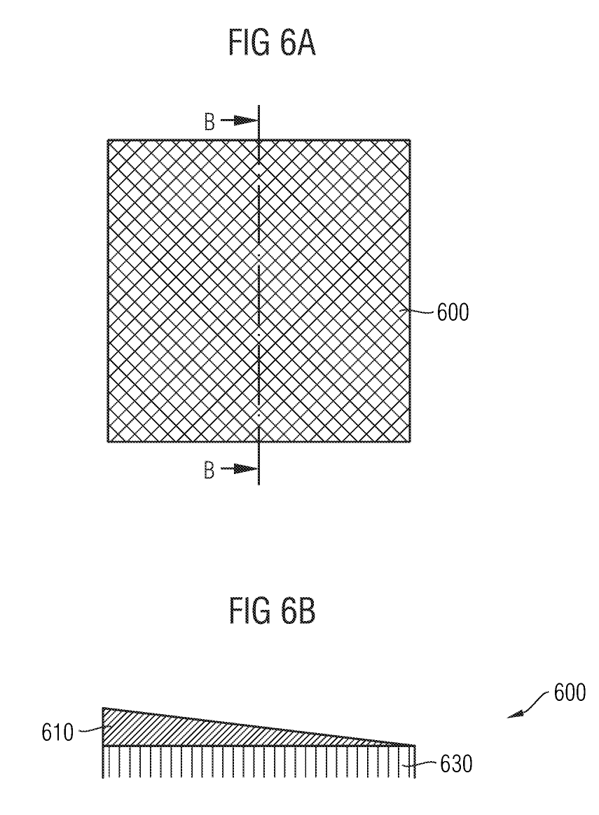

FIG. 6A is a plan view of a compensation element 600 comprising a compensation layer 610 and an EUV pellicle 630 (e.g., an EUV pellicle for reticle defect mitigation). The cross-sectional plane for FIG. 6B runs parallel to the element axis. The EUV pellicle includes a wire mesh, wherein the grid characteristics of the wire mesh are determined so as to achieve a high transparency at the illumination wavelength and sufficient mechanical stability.

The compensation layer 610 may be configured as a phase or intensity compensation layer. The embodiment of FIG. 6 may be combined with any configuration as described with regard to FIG. 5.

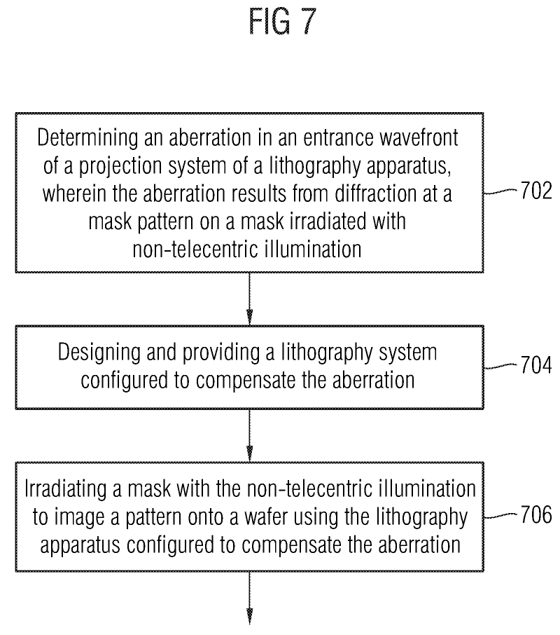

FIG. 7 is a flowchart of a method of manufacturing an integrated circuit. According to an embodiment, an aberration in an entrance wavefront of a projection system of a lithography apparatus is determined, wherein the aberration results from diffraction at a mask pattern on a mask irradiated with the non-telecentric illumination (702). The wavefront may be tilted with respect to a main plane of incidents and the intensity may vary along an axis perpendicular to the main plane of incidence.

Then, on basis of the determined aberration, a lithography system is designed and provided that is configured to compensate the aberration resulting from diffraction at a mask pattern on a mask irradiated with a non-telecentric illumination (704). For example, optical elements of the projection system of the lithography apparatus may be designed to compensate the phase shift and/or the intensity variation in the wavefront at least partly. The compensation is effective for all pitches to essentially the same degree. According to other embodiments, a compensation element is designed and provided in the optical path, for example, near a pupil plane of the lithography apparatus, wherein the compensation element is configured to compensate the aberration resulting from diffraction at a mask pattern on the mask irradiated with the non-telecentric illumination to a certain degree.

Then, a mask is irradiated with a non-telecentric illumination to image a pattern onto a wafer for manufacturing integrated circuits from the wafer, wherein the lithography apparatus, which is configured to compensate the wavefront aberration, is used (706).

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A lithography apparatus comprising:
a condenser system configured to irradiate a mask with non-telecentric incident radiation; and
a projection system configured to collect and focus a radiation diffracted at an absorber pattern on the mask to a sample, wherein the projection system is configured to compensate in the diffracted radiation an aberration resulting from the diffraction of the non-telecentric incident radiation at the absorber pattern.

2. The lithography apparatus of claim 1, wherein the aberration is a phase shift which results from different path lengths of portions of the diffracted radiation in the mask.

3. The lithography apparatus of claim 1, wherein the aberration is an intensity aberration which results from different path lengths of portions of the diffracted radiation in the mask and an absorbance of the mask at the illumination wavelength.

4. The lithography apparatus of claim 1, wherein the projection system comprises:
projection optics, configured to compensate, in the diffracted radiation, the aberration resulting from the diffraction of the non-telecentric incident radiation.

5. The lithography apparatus of claim 1, wherein the projection system comprises:
a plurality of projection optics; and
a compensation element arranged in or proximate to a pupil plane of the lithography apparatus, the compensation element being configured to compensate, in the diffracted radiation, at least one aberration resulting from the diffraction of the non-telecentric incident radiation.

6. The lithography apparatus of claim 5, wherein the compensation element comprises a coating on a surface of one of the projection optics.

7. The lithography apparatus of claim 5, wherein the compensation element comprises:
at least two sub-elements, each sub-element comprising a coating on a surface of at least one of the projection optics.

8. The lithography apparatus of claim 5, wherein the compensation element is disposed between and spaced apart from at least two of the projection optics disposed on opposing sides of the pupil plane.

9. The lithography apparatus of claim 5, wherein the compensation element is disposed on a pellicle.

10. The lithography apparatus of claim 1, wherein:
the aberration is a phase shift resulting from different path lengths of portions of the diffracted radiation in the mask; and
the compensation element comprises a phase compensation element comprising a phase shift layer having a phase shift gradient configured to compensate the phase shift in the diffracted radiation.

11. The lithography apparatus of claim 10, wherein:
a thickness of the phase shift layer decreases along a first element axis of the phase compensation element; and
the phase compensation element is oriented with the first element axis parallel to a virtual axis corresponding to the plane of incidence of the incident radiation in a direction corresponding to the non-telecentric incident radiation.

12. The lithography apparatus of claim 11, wherein the phase compensation element further comprises:
a matching layer, a thickness of the matching layer increasing along the first element axis.

13. The lithography apparatus of claim 12, wherein an absorbance of the phase compensation element is constant along the first element axis.

14. The lithography apparatus of claim 1, wherein:
the aberration is an intensity aberration resulting from different path lengths of portions of the diffracted radiation in the mask and an absorbance of the mask at the illumination wavelength; and
the compensation element comprises an intensity compensation element comprising an intensity matching layer having a transparency gradient configured to compensate the intensity aberration in the diffracted radiation.

15. The lithography apparatus of claim 14, wherein:
a thickness of the intensity matching layer decreases along a first element axis of the phase compensation element; and
the phase compensation element is oriented with the element axis parallel to a virtual axis corresponding to the plane of incidence of the incident radiation in a direction corresponding to the non-telecentric incident radiation.

16. The lithography apparatus of claim 15, the compensation element further comprising:
a matching layer configured to match the absorbance.

17. The lithography apparatus of claim 16, wherein the absorbance of the compensation element is constant along the element axis.

18. The lithography apparatus of claim 1, wherein the compensation element includes:
a combined compensation element comprising:
a phase shift layer having a phase shift gradient configured to compensate the phase shift in the diffracted radiation; and
an intensity matching layer having a transparency gradient configured to compensate the intensity aberration in the diffracted radiation.

19. The lithography apparatus of claim 18, wherein:
a thickness of the phase shift layer decreases along a first element axis of the phase compensation element; and
the phase compensation element is oriented with the first element axis parallel to a virtual axis corresponding to the plane of incidence of the incident radiation in a direction corresponding to the non-telecentric incident radiation.

20. The lithography apparatus of claim 19, wherein the phase compensation element further comprises:
a matching layer, the thickness of the matching layer increasing along the first element axis.

21. The lithography apparatus of claim 20, wherein an absorbance of the phase compensation element is constant along the first element axis.

22. The lithography apparatus of claim 18, wherein:
a thickness of the intensity matching layer decreases along a first element axis of the phase compensation element; and
the phase compensation element is oriented with the element axis parallel to a virtual axis corresponding to the plane of incidence of the incident radiation in a direction corresponding to the non-telecentric incident radiation.

23. The lithography apparatus of claim 22, the compensation element further comprising:
a matching layer configured to match the absorbance.

24. The lithography apparatus of claim 23, wherein the absorbance of the compensation element is constant along the first element axis.

25. The lithography apparatus of claim 18, wherein:
a thickness of the phase shift layer decreases along a first element axis of the compensation element;
the compensation element is oriented with the element axis parallel to a virtual axis corresponding to the plane of incidence of the incident radiation in a direction corresponding to the oblique incident radiation; and
a thickness of the intensity matching layer decreases along the first element axis of the compensation element.

26. A compensation element comprising:
at least one compensation layer configured to compensate, in a diffracted radiation, at least one aberration resulting from the diffraction of a non-telecentric incident radiation;
wherein the at least one compensation layer is further configured to be arranged in an optical path of a projection system of a lithography apparatus.

27. The compensation element of claim 26, wherein the compensation layer comprises:
a phase shift compensation layer having a phase shift gradient configured to compensate a phase shift, in the diffracted radiation, from a transparent or reflective mask.

28. The compensation element of claim 27, further comprising:
a matching layer configured to compensate an absorbance variation along an element axis.

29. The compensation element of claim 26, wherein the compensation layer comprises:
an intensity compensation layer having a transparency gradient configured to compensate an intensity aberration, in the diffracted radiation, from a transparent or reflective mask.

30. The compensation element of claim 29, further comprising:
a matching layer configured to compensate an absorbance variation along an element axis.

31. The compensation element of claim 26, wherein:
a first compensation layer comprises a phase shift compensation layer having a phase shift gradient configured to compensate a phase shift, in the diffracted radiation, from a transparent or reflective mask; and
a second compensation layer comprises an intensity compensation layer having a transparency gradient configured to compensate an intensity aberration, in the diffracted radiation, from a transparent or reflective mask.

32. The compensation element of claim 31, further comprising:
a matching layer configured to compensate an absorbance variation along an element axis.

33. The compensation element of claim 26, wherein the compensation element is arranged on a EUV pellicle.

34. A method of manufacturing an integrated circuit, the method comprising:
determining at least one aberration in an entrance wavefront of a projection system of a lithography apparatus, the aberration resulting from diffraction at a mask pattern on a mask irradiated with non-telecentric illumination;
designing and providing a lithography system configured to compensate the at least one entrance wavefront aberration; and
irradiating a mask with the non-telecentric illumination to image a pattern onto a wafer via the lithography apparatus configured to compensate the at least one entrance wavefront aberration.
